(19) United States
(12) Patent Application Publication
(10) Pub. No.: US 2023/0189212 A1
(43) Pub. Date: Jun. 15, 2023

(54) USER EQUIPMENT AND METHOD FOR MULTI-SIM OPERATION

(71) Applicant: FG Innovation Company Limited, Tuen Mun (HK)

(72) Inventors: HUNG-CHEN CHEN, Taipei (TW); MEI-JU SHIH, Taipei (TW); YUNG-LAN TSENG, Taipei (TW); CHIE-MING CHOU, Taipei (TW)

(21) Appl. No.: 17/924,761

(22) PCT Filed: May 14, 2021
(86) PCT No.: PCT/CN2021/093897

§ 371 Date: Nov. 11, 2022

Related U.S. Application Data
(60) Provisional application No. 63/025,875, filed on May 15, 2020.

(51) Int. Cl. H04W 68/02; H04W 8/18; H04W 68/12

(52) U.S. Cl. CPC H04W 68/02; H04W 8/183; H04W 68/12; H04W 88/06

(57) ABSTRACT

A user equipment and a method for a multi-Subscriber Identity Module (multi-SIM) operation are provided. The method includes registering to a first network associated with a first Subscriber Identity Module (SIM) and a second network associated with a second SIM; determining whether a paging collision associated with the first network and the second network is detected; and initiating a paging collision resolution procedure associated with a selected network to resolve the paging collision after the paging collision is detected, where the selected network is the first network or the second network.

### CROSS-REFERENCE TO RELATED APPLICATION(S)

The present application is the national stage of International Patent Application Serial No. PCT/CN2021/093897, filed on May 14, 2021, which claims the benefit of and priority to U.S. Provisional Patent Application Ser. No. 63/025,875, filed on May 15, 2020, entitled “Mechanism for Resolving Paging Collision in Multi-SIM Operation,” the contents of all of which are hereby incorporated fully by reference into the present disclosure for all purposes.

### FIELD

The present disclosure is related to wireless communication, and more specifically, to a user equipment (UE) and a method for multi-subscriber identity module (SIM) operations.

### BACKGROUND

Various efforts have been made to improve different aspects of wireless communication for cellular wireless communication systems, such as 5G NR by improving data rate, latency, reliability, and mobility. The 5G NR system is designed to provide flexibility and configurability to optimize the network services and types, accommodating various use cases such as eMBB, mMTC, and URLLC. However, as the demand for radio access continues to increase, there exists a need for further improvements in the art.

### SUMMARY

The present disclosure is related to a multi-SIM operation in cellular wireless communication networks.

According to an aspect of the present disclosure, a method for a multi-SIM operation performed by a UE is provided. The method includes registering to a first network associated with a first SIM and a second network associated with a second SIM; determining whether a paging collision associated with the first network and the second network is detected; and initiating a paging collision resolution procedure associated with a selected network to resolve the paging collision after the paging collision is detected. The selected network is the first network or the second network.

According to another aspect of the present disclosure, a UE for a multi-SIM operation is provided. The UE includes one or more non-transitory computer-readable media having computer-executable instructions embodied thereon; and at least one processor coupled to the one or more non-transitory computer-readable media, the at least one processor being configured to execute the computer-executable instructions to: register to a first network associated with a first SIM and a second network associated with a second SIM, determine whether a paging collision associated with the first network and the second network is detected, and initiate a paging collision resolution procedure associated with a selected network to resolve the paging collision after the paging collision is detected. The selected network is the first network or the second network.

### BRIEF DESCRIPTION OF THE DRAWINGS

Aspects of the disclosure are best understood from the following detailed disclosure when read with the accompanying drawings. Various features are not drawn to scale. Dimensions of various features may be arbitrarily increased or reduced for clarity of discussion.

FIG. 1 is a diagram illustrating a paging collision according to an example implementation of the present disclosure.

FIG. 2 is a flowchart illustrating a method performed by a UE for a multi-SIM operation according to an example implementation of the present disclosure.

FIG. 3 is a flowchart illustrating a method performed by a UE for a multi-SIM operation according to another example implementation of the present disclosure.

FIG. 4 is a block diagram illustrating a node for wireless communication according to an example implementation of the present disclosure.

### DESCRIPTION

The following contains specific information related to implementations of the present disclosure. The drawings and their accompanying detailed disclosure are merely directed to implementations. However, the present disclosure is not limited to these implementations. Other variations and implementations of the present disclosure will be obvious to those skilled in the art. Unless noted otherwise, like or corresponding elements among the drawings may be indicated by like or corresponding reference numerals. Moreover, the drawings and illustrations in the present disclosure are generally not to scale and are not intended to correspond to actual relative dimensions.

For the purpose of consistency and ease of understanding, like features may be identified (although, in some examples, not illustrated) by the same numerals in the drawings. However, the features in different implementations may be different in other respects and shall not be narrowly confined to what is illustrated in the drawings.

The phrases “in one implementation,” or “in some implementations,” may each refer to one or more of the same or different implementations. The term “coupled” is defined as connected whether directly or indirectly via intervening components and is not necessarily limited to physical connections. The term “comprising” means “including, but not necessarily limited to” and specifically indicates open-ended inclusion or membership in the so-disclosed combination, group, series or equivalent. The expression “at least one of A, B and C” or “at least one of the following: A, B and C” means “only A, or only B, or only C, or any combination of A, B and C.”

The terms “system” and “network” may be used interchangeably. The term “and/or” is only an association relationship for describing associated objects and represents that three relationships may exist such that A and/or B may indicate that A exists alone, A and B exist at the same time, or B exists alone. The character “/” generally represents that the associated objects are in an “or” relationship.

For the purposes of explanation and non-limitation, specific details such as functional entities, techniques, protocols, and standards are set forth for providing an understanding of the disclosed technology. In other examples, detailed disclosure of well-known methods, technologies, systems, and architectures are omitted so as not to obscure the present disclosure with unnecessary details.

Persons skilled in the art will immediately recognize that any network function(s) or algorithm(s) disclosed may be implemented by hardware, software or a combination of software and hardware. Disclosed functions may correspond to modules which may be software, hardware, firmware, or any combination thereof.

A software implementation may include computer executable instructions stored on a computer readable medium such as memory or other type of storage devices. One or more microprocessors or general-purpose computers with communication processing capability may be programmed with corresponding executable instructions and perform the disclosed network function(s) or algorithm(s).

The microprocessors or general-purpose computers may include Applications Specific Integrated Circuitry (ASIC), programmable logic arrays, and/or using one or more Digital Signal Processor (DSPs). Although some of the disclosed implementations are oriented to software installed and executing on computer hardware, alternative implementations implemented as firmware or as hardware or as a combination of hardware and software are well within the scope of the present disclosure. The computer readable medium includes but is not limited to Random Access Memory (RAM), Read Only Memory (ROM), Erasable Programmable Read-Only Memory (EPROM), Electrically Erasable Programmable Read-Only Memory (EEPROM), flash memory, Compact Disc Read-Only Memory (CD-ROM), magnetic cassettes, magnetic tape, magnetic disk storage, or any other equivalent medium capable of storing computer-readable instructions.

A radio communication network architecture such as a Long Term Evolution (LTE) system, an LTE-Advanced (LTE-A) system, an LTE-Advanced Pro system, or a 5G NR Radio Access Network (RAN) typically includes at least one base station (BS), at least one UE, and one or more optional network elements that provide connection within a network. The UE communicates with the network such as a Core Network (CN), an Evolved Packet Core (EPC) network, an Evolved Universal Terrestrial RAN (E-UTRAN), a 5G Core (5GC), or an internet via a RAN established by one or more BSs.

A UE may include but is not limited to a mobile station, a mobile terminal or device, or a user communication radio terminal. The UE may be a portable radio equipment that includes but is not limited to a mobile phone, a tablet, a wearable device, a sensor, a vehicle, or a Personal Digital Assistant (PDA) with wireless communication capability. The UE is configured to receive and transmit signals over an air interface to one or more cells in a RAN.

The BS may be configured to provide communication services according to at least a Radio Access Technology (RAT) such as Worldwide Interoperability for Microwave Access (WiMAX), Global System for Mobile communications (GSM) that is often referred to as 2G, GSM Enhanced Data rates for GSM Evolution (EDGE) RAN (GERAN), General Packet Radio Service (GPRS), Universal Mobile Telecommunication System (UMTS) that is often referred to as 3G based on basic wideband-code division multiple access (W-CDMA), high-speed packet access (HSPA), LTE, LTE-A, evolved LTE (eLTE) that is LTE connected to 5GC, NR (often referred to as 5G), and/or LTE-A Pro. However, the scope of the present disclosure is not limited to these protocols.

The BS may include but is not limited to a node B (NB) in the UMTS, an evolved node B (eNB) in LTE or LTE-A, a radio network controller (RNC) in UMTS, a BS controller (BSC) in the GSM/GERAN, an ng-eNB in an Evolved Universal Terrestrial Radio Access (E-UTRA) BS in connection with 5GC, a next generation Node B (gNB) in the 5G-RAN, or any other apparatus capable of controlling radio communication and managing radio resources within a cell. The BS may serve one or more UEs via a radio interface.

The BS is operable to provide radio coverage to a specific geographical area using a plurality of cells forming the RAN. The BS supports the operations of the cells. Each cell is operable to provide services to at least one UE within its radio coverage.

Each cell (often referred to as a serving cell) provides services to serve one or more UEs within its radio coverage such that each cell schedules the DL and optionally UL resources to at least one UE within its radio coverage for DL and optionally UL packet transmissions. The BS can communicate with one or more UEs in the radio communication system via the plurality of cells.

A cell may allocate sidelink (SL) resources for supporting Proximity Service (ProSe) or Vehicle to Everything (V2X) service. Each cell may have overlapped coverage areas with other cells.

In Multi-RAT Dual Connectivity (MR-DC) cases, the primary cell of a Master Cell Group (MCG) or a Secondary Cell Group (SCG) may be called a Special Cell (SpCell). A Primary Cell (PCell) may refer to the SpCell of an MCG. A Primary SCG Cell (PSCell) may refer to the SpCell of an SCG. MCG may refer to a group of serving cells associated with the Master Node (MN), comprising of the SpCell and optionally one or more Secondary Cells (SCells). An SCG may refer to a group of serving cells associated with the Secondary Node (SN), comprising of the SpCell and optionally one or more SCells.

As previously disclosed, the frame structure for NR supports flexible configurations for accommodating various next generation (e.g., 5G) communication requirements such as Enhanced Mobile Broadband (eMBB), Massive Machine Type Communication (mMTC), and Ultra-Reliable and Low-Latency Communication (URLLC), while fulfilling high reliability, high data rate and low latency requirements. The Orthogonal Frequency-Division Multiplexing (OFDM) technology in the 3rd Generation Partnership Project (3GPP) may serve as a baseline for an NR waveform. The scalable OFDM numerology such as adaptive sub-carrier spacing, channel bandwidth, and Cyclic Prefix (CP) may also be used.

Two coding schemes are considered for NR, specifically Low-Density Parity-Check (LDPC) code and Polar Code. The coding scheme adaption may be configured based on channel conditions and/or service applications.

At least DL transmission data, a guard period, and a UL transmission data should be included in a transmission time interval (TTI) of a single NR frame. The respective portions of the DL transmission data, the guard period, and the UL transmission data should also be configurable based on, for example, the network dynamics of NR. SL resources may also be provided in an NR frame to support ProSe services or V2X services.

Multi-USIM devices have been more and more popular in different areas and countries. For example, a user may have both a personal subscription and a business subscription in one device or has two personal subscriptions in one device for different services (e.g., one individual subscription and one “family circle” plan subscription). However, support for multi-USIM (Universal Subscriber Identity Module) within a device is currently handled in an implementation-specific manner without any support from 3GPP specifications, resulting in a variety of implementations and UE behaviors. Such situation may cause an increasing complexity for UE vendors, unexpected UE behavior for network vendors or operators, and degraded user experience. It would be beneficial to provide standardization support for a multi-USIM (or multi-SIM) UE from a performance perspective in that network functionality can be based on predictable UE behaviors.

For a multi-USIM (or multi-SIM) UE or a dual-USIM (or dual-SIM) UE, the UE may register to more than one network (e.g., a first network and a second network) from which the UE may receive pages. The term “multi-SIM” may be replaced by another term “multi-USIM”, “dual-SIM” or “dual-USIM”. That is, the terms “multi-SIM”, “multi-USIM”, “dual-SIM” and “dual-USIM” may be exchangeable in some implementations of the present disclosure. The first network may refer to as “Network A” in the present disclosure, and the second network may refer to as “Network B” in the present disclosure. Depending on UE capabilities (e.g., RX and TX capabilities), it may happen that the RX of the UE may be occupied to receive/monitor pages from Network A while pages from Network B may also be sent. Therefore, a mechanism for addressing the paging collision due to page reception when the UE is in IDLE State (e.g., radio resource control (RRC)_IDLE State) or Inactive State (e.g., RRC_INACTIVE State) in both (registered/selected) Network A and Network B associated with the respective SIMS (e.g., a first SIM and a second SIM) is required. The methods for a multi-SIM UE to resolve the paging collision in both networks associated with respective SIMS are disclosed in the present disclosure.

### Multi-SIM Operation

A multi-SIM device (or a Dual-SIM device) may operate in, but not limited to, a Dual SIM Dual Standby (DSDS) mode or a Dual SIM Dual Active (DSDA) mode, as specified in TR 22.834.

DSDS: both SIMS (including a first SIM and a second SIM) may be used for idle-mode network connection, but when a radio connection is active, the other connection is disabled. The SIMs in a DSDS device may share a single transceiver. Two radio connections may be maintained in idle mode through time multiplexing. When the UE is in-call on a network for the first SIM, it is no longer possible to maintain a radio connection to the network of the second SIM. Therefore, the connection to the network of the second SIM is unavailable for the duration of the call, while the registration of the second SIM to the second network may be maintained.

DSDA: both SIMS may be used in both idle and connected modes. Each SIM has a dedicated transceiver, meaning that there are no interdependencies on idle or connected mode operations at the modem level.

Based on the device implementation choices, several architectures for multi-SIM devices may coexist in the market to support DSDS or DSDA. The architectures for multi-SIM devices may include {single RX, single TX}, {dual RX, single TX} and {dual RX, dual TX}. RX may mean a reception antenna, a reception antenna panel, a reception antenna chain, or a reception antenna system. TX may mean a transmission antenna, a transmission antenna panel, a transmission antenna chain, or a transmission antenna system. Single RX may mean a single reception RF antenna (panel/chain/system), single TX may mean a single transmission RF antenna (panel/chain/system), dual RX may mean two reception RF antennas (panels/chains/systems) used for two networks respectively, and dual TX may mean two transmission RF antennas (panels/chains/systems) used for two networks respectively. A single RX UE may not be capable of receiving traffic from two networks at the same time, while a dual RX UE may be able to receive traffic from two networks at the same time. It should be noted that a single TX UE may not be capable of transmitting traffic to two networks at the same time, while a dual TX UE may be able to transmit traffic to two networks at the same time.

In multi-SIM scenarios, a UE may be (pre)configured or installed with at least two USIMs, each USIM may be a physical SIM or eSIM. In one implementation, the UE may be equipped with a first SIM card and a second SIM card. The UE operating in a multi-SIM mode (or a dual-SIM mode) may also be referred to as a multi-SIM UE (or a dual-SIM UE).

The USIMs of a UE may belong to the same operator or to different operators. An operator may be a public network operator (e.g., PLMN operator), or a non-public network (e.g., SNPN operator, PNI-NPN operator). The network of one USIM (e.g., associated with Network A) may be NR, LTE connected to 5GC, LTE connected EPC, multi-connectivity (e.g., EN-DC, NE-DC, NGEN-DC, NR-DC), but not limited to. For example, a UE with two USIMs may operate on Network A (e.g., NR or LTE) and Network B (e.g., NR or LTE). The core network of Network A may be the same as the core network of Network B. The core network of Network A may be different from the core network of Network B. For example, considering the case of LTE connected to EPC, Network A may refer to LTE and the core network of Network A may refer to EPC. In another example, considering the case of NR, Network A may refer to NR and the core network of Network A may refer to 5GC. The UE may be equipped with {single RX, single TX}, {dual RX, single TX}, or {dual RX, dual TX}.

### Resolving Paging Collision

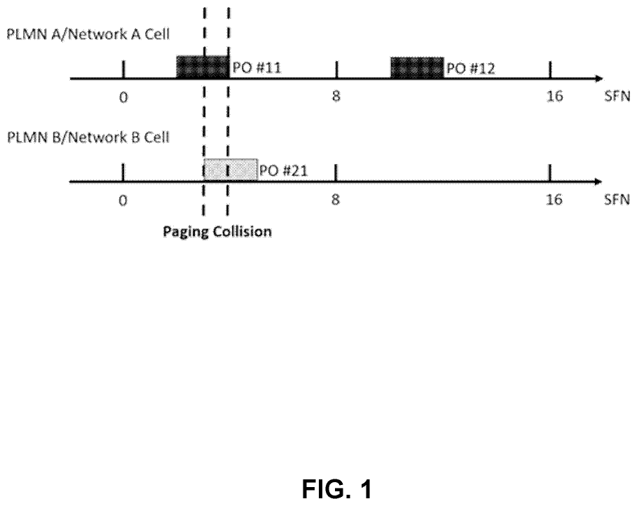

In some implementations, a UE with dual-SIM (or multi-SIM) and {single RX, single TX} may experience paging collision. The paging collision may be that the paging monitoring occasions for different SIMs (or the corresponding networks) are overlapping in the time domain and may result in missing paging (e.g., a paging DCI or a paging message may be missed from the UE's perspective). FIG. 1 is a diagram illustrating a paging collision, in accordance with an implementation of the present disclosure. For example, as shown in FIG. 1, a UE with dual-SIM (or multi-SIM) and {single RX, single TX} may camp on a cell of PLMN A (or Network A) associated with a first SIM and camp on a cell of PLMN B (or Network B) associated with a second SIM. Based on the corresponding paging factors (or parameters) of PLMN A (or Network A), the UE may monitor paging occasion PO #11, PO #12, and the following paging occasions in the time domain. Based on the corresponding paging factors (or parameters) of PLMN B (or Network B), the UE may monitor paging occasion PO #21 and the following paging occasions in the time domain. As result, PO #11 and PO #21 are overlapping in the time domain and the UE may experience a paging collision accordingly. For example, based on the PF/PO formula with paging factors (or parameters) of PLMN A (or Network A), the UE may derive the time resource location and/or frequency resource location of PO #11. Based on the PF/PO formula with paging factors (or parameters) of PLMN B (or Network B), the UE may derive the time resource location and/or frequency resource location of PO #21. The PF/PO formula captured in 3GPP TS 38.304 or TS 36.304 may be applied. However, if the time and/or frequency resource location of PO #11 and the time and/or frequency resource location of PO #21 overlaps (e.g., partially overlaps or fully overlaps), the UE with single RX may not successfully receive and decode both the paging DCI (or the corresponding paging message) from the cell of Network A in PO #11 and the paging DCI (or the corresponding paging message) from the cell of Network B in PO #21. In some implementations, when PLMN A (or Network A/Network A cell) and PLMN B (or Network B/Network B cell) are operating on the same spectrum/frequency band/frequency carrier, a UE with dual-SIM (or multi-SIM) and {single RX, single TX} may not experience paging collision. In some implementations, when PLMN A (or Network A/Network A cell) and PLMN B (or Network B/Network B cell) are operating on the same spectrum/frequency band/frequency carrier, a UE with dual-SIM (or multi-SIM) and {single RX, single TX} may not perform any mechanism (e.g., initiate a paging collision resolution procedure) for paging collision resolution (e.g., omit monitoring a PO of one of the network or apply new paging parameters/factors of one of the networks).

In some implementations, a UE may consider a network as active if an associated SIM/USIM of the network is switched on/turned on/plugged in/installed. In some implementations, a UE may consider a network as active if the UE registers to the network or sign in the network. In some implementations, a UE may consider a network as active if one suitable cell of the network is (re)selected by the UE. In some implementations, a UE may consider a network as active if one acceptable cell of the network is (re)selected by the UE. In some implementations, a UE may consider a network as active if at least one suitable cell of the network or one acceptable cell of the network is (re)selected by the UE. It is noted that the cell selection/cell reselection mechanism for suitable cell(s) or acceptable cell(s) captured in 3GPP TS 38.304 or TS 36.304 may be applied. The definitions of suitable cell(s) or acceptable cell(s) captured in 3GPP Technical Specification (TS) 38.304 or TS 36.304 may be applied.

In some implementations, a UE may consider a network as inactive if an associated SIM/USIM of the network is switched off/turned off/unplugged/uninstalled. In some implementations, a UE may consider a network as inactive if the UE does not register to the network or sign out the network. In some implementations, a UE may consider a network as inactive if no suitable cell of the network is (re)selected by the UE. In some implementations, a UE may consider a network as inactive if no acceptable cell of the network is (re)selected by the UE. In some implementations, a UE may consider a network as inactive if neither one suitable cell of the network nor one acceptable cell of the network is (re)selected by the UE. It is noted that the cell selection/cell reselection mechanism for suitable cell(s) or acceptable cell(s) captured in 3GPP TS 38.304 or TS 36.304 may be applied. The definitions of suitable cell(s) or acceptable cell(s) captured in 3GPP TS 38.304 or TS 36.304 may be applied.

In some implementations, upper layers (e.g., non-access stratum (NAS) layer or Application layer) of a UE may inform lower layers (e.g., RRC layer) of the UE that the multi-SIM operation (or dual-SIM operation) is on or off (or be activated/de-activated). For example, if a UE successfully registered to a first network associated with a first SIM and a second network associated with a second SIM, (upper layers of) a UE may determine that the multi-SIM operation (or dual-SIM operation) is on (or be activated). In another example, if the multi-SIM operation (or dual-SIM operation) is on (or be activated) but a UE deregistered to a first network associated with a first SIM, (upper layers of) a UE may determine that the multi-SIM operation (or dual-SIM operation) is off (or be deactivated).

In some implementations, a multi-SIM capable UE (or a dual-SIM capable UE) may have a common upper layer (e.g., a NAS layer or an Application layer) and the common upper layer may inform lower layers (e.g., RRC layer) of the UE that the multi-SIM operation (or dual-SIM operation) is on or off (or be activated/de-activated).

In some implementations, a multi-SIM capable UE (or a dual-SIM capable UE) may have individual upper layers (e.g., one NAS layer for network A associated with a first SIM and the other NAS layer for network B associated with a second SIM) and each of the individual upper layer may inform associated lower layer(s) (e.g., RRC layer) of the UE that the multi-SIM operation (or dual-SIM operation) is on or off (or be activated/de-activated). For example, the UE's NAS layer of Network A associated with the first SIM may inform the UE's RRC layer of Network A that the multi-SIM operation (or dual-SIM operation) is on or off (or be activated/de-activated). The UE's NAS layer of Network B associated with the second SIM may inform the UE's RRC layer of Network B that the multi-SIM operation (or dual-SIM operation) is on or off (or be activated/de-activated).

In some implementations, a multi-SIM capable UE (or a dual-SIM capable UE) may have individual upper layers (e.g., one NAS layer for Network A associated with a first SIM and the other NAS layer for Network B associated with a second SIM) and only one of the individual upper layers may inform associated lower layers (e.g., RRC layer) of the UE that the multi-SIM operation (or dual-SIM operation) is on or off (or be activated/de-activated).

In some implementations, a multi-SIM capable UE (or a dual-SIM capable UE) may have individual upper layers (e.g., one NAS layer for Network A associated with a first SIM and the other NAS layer for Network B associated with a second SIM) and only the individual upper layer of a selected network may inform associated lower layers (e.g., RRC layer) of the UE that the multi-SIM operation (or dual-SIM operation) is on or off (or be activated/de-activated). The selected network may be determined based on pre-defined rule(s), pre-configuration(s), policy(ies) (e.g., based on channel quality results and/or S-criteria and/or operating frequency bands), or UE implementation(s) (e.g., the network(s) associated with a SIM/USIM that is plugged in/installed first or manual selected).

In some implementations, individual upper layers (e.g., the upper layers of the UE) may exchange the information about a network status (e.g., whether the associated network is active or inactive) (e.g., via core network signaling, via UE internal signaling). For example, assume that Network A associated with the first SIM is firstly active (or turned on). Later, Network B associated with the second SIM is also active (or turned on). The upper layer associated with the Network B (or the second SIM) of the UE may inform associated lower layers (e.g., RRC layer) of the UE that the multi-SIM operation (or dual-SIM operation) is on. For example, assume that Network A associated with the first SIM and Network B associated with the second SIM are both active (or turned on). Later, Network B associated with the second SIM is inactive (or turned off). The upper layer associated with Network B (or the second SIM) of the UE may inform associated lower layers (e.g., RRC layer) of the UE that the multi-SIM operation (or dual-SIM operation) is off. In another example, assume that Network A associated with the first SIM and Network B associated with the second SIM are both active (or turned on). Later, Network B associated with the second SIM is inactive (or turned off). The upper layer associated with the Network A (or the first SIM) of the UE may inform associated lower layers (e.g., RRC layer) of the UE that the multi-SIM operation (or dual-SIM operation) is off.

In some implementations, individual lower layers (e.g., RRC layers of the UE) may exchange information about the network status (e.g., whether the associated network is active or inactive) (e.g., via core network signaling, via UE internal signaling). For example, the RRC layer associated with Network A of a UE and the RRC layer associated with Network B of the UE may exchange such information. In some implementations, individual upper layer associated with Network A of a UE may inform lower layer associated with Network B of the UE about the network status.

In some implementations, upper layers (e.g., NAS layer or Application layer) of a UE may inform lower layers (e.g., RRC layer) of the UE that the multi-SIM operation (or dual-SIM operation) is off and/or which network is active (or inactive). For example, assume that Network A is associated with a first SIM and Network B is associated with a second SIM. While the multi-SIM operation is on and turned off later (e.g., the second SIM is disabled), upper layers (e.g., NAS layer or Application layer) of a UE may inform lower layers (e.g., RRC layer) of the UE that Network A is active (or Network B is not active).

In some implementations, a multi-SIM capable UE (or a dual-SIM capable UE) may have a common upper layer (e.g., a NAS layer or an Application layer) and the common upper layer may inform lower layers (e.g., RRC layer) of the UE that the multi-SIM operation (or dual-SIM operation) is off and/or which network is active (or inactive).

In some implementations, a multi-SIM capable UE (or a dual-SIM capable UE) may have individual or separate upper layers (e.g., one NAS layer for Network A associated with a first SIM and another NAS layer for Network B associated with a second SIM) and each of the individual upper layers may inform its associated lower layers (e.g., RRC layer) of the UE that the multi-SIM operation (or dual-SIM operation) is off and/or the associated network is active (or inactive).

In some implementations, a multi-SIM capable UE (or a dual-SIM capable UE) may have individual or separate upper layers (e.g., one NAS layer for Network A associated with a first SIM and another NAS layer for Network B associated with a second SIM) and only one of the individual upper layers may inform its associated lower layers (e.g., RRC layer) of the UE that the multi-SIM operation (or dual-SIM operation) is off and/or which network is active (or inactive).

In some implementations, a multi-SIM capable UE (or a dual-SIM capable UE) may have individual or separate upper layers (e.g., one NAS layer for Network A associated with a first SIM and another NAS layer for Network B associated with a second SIM) and only the individual upper layer of a selected network may inform associated lower layers (e.g., RRC layer) of the UE that the multi-SIM operation (or dual-SIM operation) is off and/or which network is active (or inactive). The selected network may be determined based on pre-defined rule(s), pre-configuration(s), policy(ies), or UE implementation(s) (e.g., the network(s) associated with a SIM/USIM that is plugged in/installed first or manual selected).

In some implementations, individual upper layers (e.g., the upper layers of the UE) may exchange the information about the network status (e.g., if the associated network is active or inactive). For example, assume that Network A associated with the first SIM and Network B associated with the second SIM are both active (or turned on). Later, Network B associated with the second SIM is inactive (or turned off). The upper layer associated with the Network B (or the second SIM) of the UE may inform associated lower layers (e.g., RRC layer) of the UE that the multi-SIM operation (or dual-SIM operation) is off and the status of Network B is inactive. For another example, assume that Network A associated with the first SIM and Network B associated with the second SIM are both active (or turned on). Later, network B associated with the second SIM is inactive (or turned off). The upper layer associated with Network B (or the second SIM) of the UE may inform the lower layers (e.g., RRC layer) associated with Network A of the UE that the multi-SIM operation (or dual-SIM operation) is off and/or the status of Network B is inactive.

In some implementations, the priority(ies) of each network (or the related PLMN) associated with each (active) SIM/USIM may be determined based on pre-defined rule(s), pre-configuration(s), policy(ies), or UE implementations (e.g., the network(s) associated with a SIM/USIM that is plugged in/installed first or manual selected).

In some implementations, the priority(ies) of each network (or the related PLMN) associated with each (active) SIM/USIM may be determined based on the associated RRC state. For example, if a UE is in RRC_IDLE in Network A and is in RRC_INACITVE state in Network B, the priority of Network B may be considered higher than the priority of Network A.

In some implementations, the priority(ies) of each network (or the related PLMN) associated with each (active) SIM/USIM may be determined based on network type (e.g., public network or private network). For example, if Network A is a public network and Network B is a private network (e.g., Standalone Non-Public Network/SNPN or closed access group/CAG), the priority of Network B may be considered higher than the priority of Network A.

In some implementations, the priority(ies) of each network (or the related PLMN) associated with each (active) SIM/USIM may be determined based on the serving frequencies. For example, if Network A is operating on a non-ITS (Intelligent Transport System) band and Network B is operating on an ITS band, the priority of Network B may be considered higher than the priority of Network A.

In some implementations, the priority(ies) of each network (or the related PLMN) associated with each (active) SIM/USIM may be determined based on the associated core network (e.g., EPC or 5GC). For example, if Network A is associated with EPC and Network B is associated with 5GC, the priority of Network B may be considered higher than the priority of Network A.

In some implementations, a UE may jointly consider different factors (e.g., RRC state(s), network type(s), serving frequency(ies) or core network type(s)) to determine a priority of a network (or the related PLMN).

In some implementations, upper layers (e.g., NAS layer or Application layer) of a UE may inform lower layers (e.g., RRC layer) of the UE that the multi-SIM operation (or dual-SIM operation) is on or off (or be activated/de-activated), and/or the priority of the network (that is associated with a respective SIM).

In some implementations, a multi-SIM capable UE (or a dual-SIM capable UE) may have individual or separate upper layers (e.g., one NAS layer for Network A associated with the first SIM and another NAS layer for Network B associated with the second SIM) and each individual upper layer may inform associated lower layers (e.g., RRC layer) of the UE that the multi-SIM operation (or dual-SIM operation) is on or off (or be activated/de-activated), and/or the priority of the network (that is associated with a respective SIM).

In some implementations, upper layers (e.g., NAS layer or Application layer) of a UE may inform lower layers (e.g., RRC layer) of the UE that the multi-SIM operation (or dual-SIM operation) is on or off (or be activated/de-activated), and/or one of the networks (that is associated with a respective SIM) is with highest/higher priority (or lowest/lower priority). For example, assume that Network A is associated with the first SIM and Network B is associated with the second SIM. While the multi-SIM operation is on, Network A may be indicated as the network with highest/higher priority.

In some implementations, upper layers (e.g., NAS layer or Application layer) of a UE may inform lower layers (e.g., RRC layer) of the UE that the multi-SIM operation (or dual-SIM operation) is on or off (or be activated/de-activated), and/or one of the selected PLMNs (that is associated with a respective SIM or a network) is with highest/higher priority (or lowest/lower priority).

In some implementations, a multi-SIM capable UE (or a dual-SIM capable UE) may have a common upper layer (e.g., a NAS layer or an Application layer) and the common upper layer may inform lower layers (e.g., RRC layer) of the UE that the multi-SIM operation (or dual-SIM operation) is on or off (or be activated/de-activated), and/or one of the networks (that is associated with a respective SIM) is with highest/higher priority (or lowest/lower priority).

In some implementations, a multi-SIM capable UE (or a dual-SIM capable UE) may have individual or separate upper layers (e.g., one NAS layer for network A associated with the first SIM and the other NAS layer for network B associated with the second SIM) and each of the individual upper layer may inform associated lower layers (e.g., RRC layer) of the UE that the multi-SIM operation (or dual-SIM operation) is on or off (or be activated/de-activated), and/or the associated network (that is associated with a respective SIM) is with highest/higher priority (or lowest/lower priority).

In some implementations, a multi-SIM capable UE (or a dual-SIM capable UE) may have individual or separate upper layers (e.g., one NAS layer for Network A associated with the first SIM and another NAS layer for Network B associated with the second SIM) and only one of the individual upper layers may inform associated lower layers (e.g., RRC layer) of the UE that the multi-SIM operation (or dual-SIM operation) is on or off (or be activated/de-activated), and/or one of the networks (that is associated with a respective SIM) is with highest/higher priority (or lowest/lower priority).

In some implementations, a multi-SIM capable UE (or a dual-SIM capable UE) may have individual or separate upper layers (e.g., one NAS layer for Network A associated with the first SIM and another NAS layer for Network B associated with the second SIM) and only the individual upper layer of a selected network may inform associated lower layers (e.g., RRC layer) of the UE that the multi-SIM operation (or dual-SIM operation) is on or off (or be activated/de-activated), and/or one of the networks (that is associated with a respective SIM) is with highest/higher priority (or lowest/lower priority). The selected network may be determined based on pre-defined rule(s), pre-configuration(s), policy(ies), or UE implementation(s) (e.g., the network(s) associated with a SIM/USIM that is plugged in/installed first or manual selected).

In some implementations, individual upper layers (e.g., the upper layers of the UE) may exchange the information about the network status (e.g., if the associated network is active or inactive). For example, assume that Network A associated with the first SIM is first active (or turned on). Later, Network B associated with the second SIM is also active (or turned on). The upper layer associated with Network B (or the second SIM) of the UE may inform associated lower layers (e.g., RRC layer) of the UE that the multi-SIM operation (or dual-SIM operation) is on and Network B is with highest/higher priority (or lowest/lower priority). For example, assume that Network A associated with the first SIM and Network B associated with the second SIM are both active (or turned on). Later, Network B associated with the second SIM is inactive (or turned off). The upper layer associated with tNetwork B (or the second SIM) of the UE may inform associated lower layers (e.g., RRC layer) of the UE that the multi-SIM operation (or dual-SIM operation) is off.

In some implementations, individual lower layers (e.g., RRC layers of the UE) may exchange the information about the network status (e.g., the priority of the related network) (e.g., via core network signaling, via UE internal signaling). For example, RRC layer associated with Network A of a UE and RRC layer associated with Network B of the UE may exchange such information.

In some implementations, individual upper layer associated with Network A of a UE may inform lower layer associated with Network B of the UE about the network status.

In some implementations, upper layers (e.g., NAS layer or Application layer) of a UE may inform lower layers (e.g., RRC layer) of the UE about the architecture for supporting multi-SIM operation/dual-SIM operation. For example, upper layers (e.g., NAS layer or Application layer) of a UE may report/inform/configure the architecture for supporting multi-SIM operation to be {single RX, single TX} to lower layers (e.g., RRC layer) of the UE. For example, upper layer (e.g., NAS layer or Application layer) of a UE may report/inform/configure the architecture for supporting multi-SIM operation to be {dual RX, single TX} to lower layers (e.g., RRC layer) of the UE.

In some implementations, a multi-SIM capable UE (or a dual-SIM capable UE) may have a common upper layer (e.g., a NAS layer or an Application layer) that may inform lower layers (e.g., RRC layer) of the UE about the architecture for supporting multi-SIM/dual-SIM operation.

In some implementations, a multi-SIM capable UE (or a dual-SIM capable UE) may have individual or separate upper layers (e.g., one NAS layer for Network A associated with the first SIM and another NAS layer for Network B associated with the second SIM) and each of the individual upper layer may inform associated lower layers (e.g., RRC layer) of the UE about the architecture for supporting multi-SIM/dual-SIM operation.

In some implementations, a multi-SIM capable UE (or a dual-SIM capable UE) may have individual or separate upper layers (e.g., one NAS layer for Network A associated with the first SIM and another NAS layer for Network B associated with the second SIM) and only one of the individual upper layers may inform associated lower layers (e.g., RRC layer) about the architecture for supporting multi-SIM/dual-SIM operation.

In some implementations, a multi-SIM capable UE (or a dual-SIM capable UE) may have individual or separate upper layers (e.g., one NAS layer for network A associated with the first SIM and the other NAS layer for network B associated with the second SIM) and only the individual upper layer of a selected network may inform associated lower layers (e.g., RRC layer) of the UE about the architecture for supporting multi-SIM/dual-SIM operation. The selected network may be determined based on pre-defined rule(s), pre-configuration(s), policy(ies), or UE implementation(s) (e.g., the network(s) associated with a SIM/USIM that is plugged in/installed first or manual selected).

### Paging Collision Resolution

In some implementations, if the multi-SIM operation/dual-SIM operation of a UE is on, the UE may monitor at least one paging occasion (PO) per DRX cycle for a network that is associated with a respective SIM. It is noted that one Paging Frame (PF) is one Radio Frame and may contain one or more PO(s) or starting point of a PO. The UE may determine the paging frame(s) and paging occasion(s) for paging based on a pre-defined formula (e.g., the formula defined in TS 38.304 v16.0.0) based on the parameters (or factors) received from the respective network (or the cell). The UE may receive pages (e.g., paging DCI) based on the determined PO(s) (or PF(s)) of both networks. For example, if the multi-SIM operation/dual-SIM operation of a UE is on and Network A is associated with the first SIM and Network B is associated with the second SIM, the UE may determine the paging frame(s) and paging occasion(s) for paging from Network A based on the parameters configured by Network A (e.g., via broadcasting system information, via RRC message (e.g., RRC Release with suspend configuration, RRC Release without suspend configuration)) and the UE may also determine the paging frame(s) and paging occasion(s) for paging from Network B based on the parameters configured by Network B (e.g., via broadcasting system information, via RRC message (e.g., RRC Release with suspend configuration, RRC Release without suspend configuration)). The UE may monitor the determined PO(s) of Network A for receiving pages (e.g., paging DCI). The UE may monitor the determined PO(s) of Network B for receiving pages. In some implementations, based on the determination, a PO (or a PF) of Network A may collide with a PO (of a PF) of a Network B. In some implementations, if monitoring both collided POs (or PFs) for receiving pages (e.g., paging DCI) is possible (e.g., the architecture for supporting multi-SIM operation/dual-SIM operation is {dual RX, single TX}), the UE may receive pages from both collided POs (or PFs).

### Solution #1

In some implementations, if monitoring both collided POs (or PFs) for receiving pages (e.g., paging DCI) is not possible (e.g., the architecture for supporting multi-SIM operation/dual-SIM operation is {single RX, single TX}), the UE may monitor pages from one of the collided POs (or PFs). In some implementations, if monitoring both collided POs (or PFs) for receiving pages (e.g., paging DCI) is not possible (e.g., the architecture for supporting multi-SIM operation/dual-SIM operation is {single RX, single TX}), the UE may (randomly) select one of the collided POs (or PFs) and monitor the selected collided PO (or PF) for receiving pages (e.g., paging DCI). In some implementations, if monitoring both collided POs (or PFs) for receiving pages (e.g., paging DCI) is not possible (e.g., the architecture for supporting multi-SIM operation/dual-SIM operation is {single RX, single TX}), the UE may monitor the collided PO (or PF) of the network (or selected PLMN) with the highest/higher priority for receiving pages (e.g., paging DCI). The priority of a network (or PLMN) associated with a respective SIM may be pre-defined/per-configured or informed by upper layers (e.g., NAS layer or Application layer). In some implementations, if monitoring both collided POs (or PFs) for receiving pages (e.g., paging DCI) is not possible (e.g., the architecture for supporting multi-SIM operation/dual-SIM operation is {single RX, single TX}), the UE may monitor the collided PO (or PF) of the network (or selected PLMN) wherein the UE may just monitor another PO (or another PF) of the other network (or selected PLMN) before the current (collided) PO. For example, if a UE determines that there are collided PO(s) among Network A and Network B, the UE may first monitor a collided PO of Network A and then monitor a next collided PO of Network B.

In some implementations, if monitoring both collided POs (or PFs) for receiving pages (e.g., paging DCI) is not possible (e.g., the architecture for supporting multi-SIM operation/dual-SIM operation is {single RX, single TX}), the UE may omit monitoring the collided PO (or PF) of the impacted network (or selected PLMN). In some implementations, in case of multi-SIM operation/dual-SIM operation is on and both a network associated with E-UTRA and a network associated with NR are active, a network associated with NR may be considered to be impacted if a PO (or a PF) determined based on its paging parameters collides with another PO (or another PF) determined based on the paging parameters of the network associated with E-UTRA. In some implementations, in case of multi-SIM operation/dual-SIM operation is on and both a network associated with E-UTRA and a network associated with NR are active, a network associated with E-UTRA may be considered to be impacted if a PO (or a PF) determined based on its paging parameters collides with another PO (or another PF) determined based on the paging parameters of the network associated with NR. In some implementations, in case of multi-SIM operation/dual-SIM operation is on and both networks are associated with same Radio Access Technology/RAT (e.g., NR or LTE), if a PO (or a PF) determined based on the paging parameters of Network A collides with another PO (or another PF) determined based on the paging parameters of Network B, a UE may (randomly) select one network as the impacted network. In some implementations, in case of multi-SIM operation/dual-SIM operation is on and both networks are associated with same RAT (e.g., NR or LTE), if a PO (or a PF) determined based on the paging parameters of Network A collides with another PO (or another PF) determined based on the paging parameters of Network B, a UE may select one network with lowest/lower priority as the impacted network. In some implementations, in case of multi-SIM operation/dual-SIM operation is on and both networks are associated with same RAT (e.g., NR or LTE), if a PO (or a PF) determined based on the paging parameters of Network A collides with another PO (or another PF) determined based on the paging parameters of Network B, a UE may select one network as the impacted network based on the pre-defined rules/configuration/policy, UE implementations, or UE setting (e.g., based on the information provided by NAS layer or Application layer).

In some implementations, if the multi-SIM operation (or dual-SIM operation) is off and only one of the networks is active, the UE may keep monitoring PO(s) of the active network and stop monitoring PO(s) of the network that is not active. In some implementations, if the multi-SIM operation (or dual-SIM operation) is off and a network becomes inactive (or is turned off), the UE may keep the corresponding paging parameters (or paging factors) (e.g., PO offset, PF offset, or UE-ID offset used in paging formula) of the inactive network. In some implementations, if the multi-SIM operation (or dual-SIM operation) is off and a network becomes inactive (or is turned off), the UE may release the corresponding paging parameters (or paging factors) (e.g., PO offset, PF offset, or UE-ID offset used in paging formula) of the inactive network. In some implementations, if the multi-SIM operation (or dual-SIM operation) is off and only one of the networks is active, the UE may stop monitoring the paging occasion of the inactive network. For example, assume that Network A associated with the first SIM and Network B associated with the second SIM are both active (or turned on). Later, Network B associated with the second SIM is inactive (or turned off). The UE may not monitor the paging occasion of Network B. Instead, since Network A is still active, the UE may keep monitoring the paging occasion of Network A.

In some implementations, if at least one collided PO (or PF) is determined, the UE may omit monitor pages from one of the networks. For example, if the multi-SIM operation (or dual-SIM operation) of a UE is on and at least one collided PO (or PF) is determined by the UE based on the paging parameters (or factors) from Network A and the paging parameters (or factors) from Network B, the UE may omit monitoring (any or all) PO(s) of Network B (e.g., Network B is with lowest/lower priority or Network B is selected based on pre-configuration/pre-defined rules/UE implementations).

In some implementations, as shown in FIG. 1, when PLMN A (or Network B/Network A cell) and PLMN B (or Network B/Network B cell) are operating on the same spectrum/frequency band/frequency carrier, some UEs with dual-SIM (or multi-SIM) and {single RX, single TX} may not perform the related implementations of solution #1 for paging collision resolution.

### Solution #2

In some implementations, if the determined collided PO(s)/PF(s) is below (or equal to) a collision rate, a UE may only apply solutions without NW involvement (e.g., Solution #1). In some implementations, if the determined collided PO(s)/PF(s) is above (or equal to) a collision rate, a UE may be allowed to apply solutions with NW involvement (e.g., Solution #2). In some implementations, a collision rate may be configurable or pre-defined. In some implementations, a collision rate may be provided via system information or via dedicated signaling. In some implementations, a collision rate may be a number of collided PO(s) (or a number of collided PF(s)) within a time period. The time period may be configurable or pre-defined. The time period may be provided via system information or via dedicated signaling.

In some implementations, a network (or an associated base station/cell) may indicate (e.g., via broadcasting system information or dedicated signaling) whether paging collision resolution is supported. In some implementations, if paging collision resolution is indicated (or supported) and a UE encounters a problem of paging collision (e.g., a PO of Network A may collide with a PO of Network B), a UE may initiate a paging collision resolution procedure. In some implementations, a UE may inform a network (e.g., a network that is impacted or with lowest/lower priority or a network that is selected based on the pre-configuration/pre-defined rules/UE implementations) about the initiation of a paging collision resolution procedure or the intention to initiate a paging collision resolution procedure. It is noted that in case of multi-SIM operation/dual-SIM operation is on (i.e., both Network A and Network B are active (or turned on)), Network A may be considered to be impacted if a PO (or a PF) determined based on the paging parameters of Network A collides with another PO (or another PF) determined based on the paging parameters of Network B. In some implementations, in case of multi-SIM operation/dual-SIM operation is on and both a network associated with E-UTRA and a network associated with NR are active, the network associated with NR may be considered to be impacted if a PO (or a PF) determined based on its paging parameters collides with another PO (or another PF) determined based on the paging parameters of the network associated with E-UTRA. In some implementations, in case of multi-SIM operation/dual-SIM operation is on and both a network associated with E-UTRA and a network associated with NR are active, the network associated with E-UTRA may be considered to be impacted if a PO (or a PF) determined based on its paging parameters collides with another PO (or another PF) determined based on the paging parameters of the network associated with NR. In some implementations, in case of multi-SIM operation/dual-SIM operation is on and both networks are associated with same RAT (e.g., NR or LTE), if a PO (or a PF) determined based on the paging parameters of Network A collides with another PO (or another PF) determined based on the paging parameters of Network B, a UE may (randomly) select one network as the impacted network. In some implementations, in case of multi-SIM operation/dual-SIM operation is on and both networks are associated with same RAT (e.g., NR or LTE), if a PO (or a PF) determined based on the paging parameters of Network A collides with another PO (or another PF) determined based on the paging parameters of Network B, a UE may select the network with the lowest/lower priority as the impacted network. In some implementations, in case of multi-SIM operation/dual-SIM operation is on and both networks are associated with same RAT (e.g., NR or LTE), if a PO (or a PF) determined based on the paging parameters of Network A collides with another PO (or another PF) determined based on the paging parameters of Network B, a UE may select a network as the impacted network based on the pre-defined rules/configuration/policy, UE implementations, or UE setting (e.g., based on the information provided by NAS layer or Application layer).

In some implementations, a UE may provide an assistance information to a network for resolving paging collision. In some implementations, a UE may be allowed to initiate/apply a paging collision resolution procedure after receiving a NW command or response (e.g., the response from the NW after sending an information about the intention to initiate the paging collision resolution procedure). In some implementations, after initiating the paging collision resolution procedure/applying a paging collision resolution, if a collided PO (or PF) still happens, the UE may monitor the collided PO (or PF) of the network (or selected PLMN) with the highest/higher priority for receiving pages (e.g., paging DCI), monitor the collided PO (or PF) of the network/PLMN (randomly) selected by UE, or apply the corresponding implementations and designs (e.g., the implementations related to Solution #1). In some implementations, after applying paging collision resolution of Solution #2, if collided POs (or PFs) for receiving pages (e.g., paging DCI) still exist, the UE may apply paging collision resolution of Solution #1.

In some implementations, a UE may apply pre-defined/pre-configured (or dummy) paging parameters to determine PO(s) or PF(s) of a network (or PLMN) (e.g., upon initiating/applying a paging collision resolution procedure or upon the NW response). Pre-defined/pre-configured (or dummy) paging parameters may be provided via system information or dedicated signaling. Pre-defined/pre-configured (or dummy) paging parameters may be pre-defined or specified. For example, if a UE determines that at least one PO (or PF) of Network A may collide with a PO (of a PF) of Network B, the UE may apply the pre-defined (or dummy) paging parameters to derive one or more new POs (or PFs) of Network B to try to avoid paging collision. For example, if a UE determines that at least one PO (or PF) of Network A may collide with a PO (of a PF) of Network B, the UE may apply the pre-defined (or dummy) paging parameters to derive one or more new POs (or PFs) for the network with the lowest/lower priority (in comparison with the NW with the highest priority) or for the impacted network to try to avoid paging collision. It is noted that the priority(ies) of each network associated with each active SIM/USIM may be determined based on pre-defined rule(s), pre-configuration(s), policy(ies), or UE implementation(s) (e.g., the network(s) associated with a SIM/USIM that is plugged in/installed first or manual selected). For example, if a UE determines that at least one PO (or PF) of network A may collide with a PO (of a PF) of a network B, the UE may apply the pre-defined (or dummy) paging parameters to derive the new PO(s) or PF(s) of a network selected by the UE or based on the pre-defined rules/configurations/policy to try to avoid paging collision. In some implementations, a UE may stop applying pre-defined (or dummy) paging parameters to determine PO(s) or PF(s) of a network (or PLMN) when the camped cell associated the impacted network (or PLMN) changes (e.g., due to cell reselection). In some implementations, a UE may stop applying pre-defined (or dummy) paging parameters to determine PO(s) or PF(s) of a network (or PLMN) when a camped cell of the network (or PLMN) changes (e.g., due to cell reselection). In some implementations, a UE may stop applying pre-defined (or dummy) paging parameters to determine PO(s) or PF(s) of a network (or PLMN) when the UE connects to the network (e.g., transition to RRC_CONNECTED state) or when the UE connects to another network (e.g., transition to RRC_CONNECTED state).

In some implementations, a UE may start monitoring reserved PO(s) or reserved PF(s) of a network for receiving pages (e.g., paging DCI) (e.g., upon initiating/applying a paging collision resolution procedure or upon the NW response). Reserved PO(s) or reserved PF(s) may be provided via system information or dedicated signaling. Reserved PO(s) or reserved PF(s) may be pre-defined or specified. For example, if a UE determines that at least one PO (or PF) of Network A may collide with a PO (of a PF) of Network B, the UE may start monitoring the reserved PO(s) or reserved PF(s) of a network with the lowest/lower priority for receiving pages (e.g., paging DCI) or an impacted network to try to avoid paging collision. For example, if a UE determines that at least one PO (or PF) of Network A may collide with a PO (of a PF) of Network B, the UE may start monitoring the reserved PO(s) or reserved PF(s) of a network selected by the UE or selected based on the pre-defined rules/configurations/policy for receiving pages (e.g., paging DCI) to try to avoid paging collision. In some implementations, a UE may stop monitoring reserved PO(s) or reserved PF(s) of a network (or PLMN) when the camped cell associated the impacted network (or PLMN) changes (e.g., due to cell reselection). In some implementations, a UE may stop monitoring reserved PO(s) or reserved PF(s) of a network (or PLMN) when a camped cell of the network (or PLMN) changes (e.g., due to cell reselection). In some implementations, a UE may stop monitoring reserved PO(s) or reserved PF(s) of a network (or PLMN) when the UE connects to the network (e.g., transition to RRC_CONNECTED state) or when the UE connects to another network (e.g., transition to RRC_CONNECTED state).

In some implementations, a UE may apply new paging parameters or paging information (e.g., PO offset/PF offset) indicated in a NW command to derive/determine the new PO(s) or PF(s) to monitor for receiving pages (e.g., paging DCI) (e.g., upon initiating/applying a paging collision resolution procedure or upon the NW response). For example, if a UE determines that at least one PO (or PF) of Network A may collide with a PO (of a PF) of Network B, the UE may inform a network with the lowest/lower priority or an impacted network to resolve paging collision. For example, if a UE determines that at least one PO (or PF) of Network A may collide with a PO (of a PF) of Network B, the UE may inform a network selected by the UE or selected based on the pre-defined rules/configurations/policy to resolve paging collision. The network being informed may provide new paging parameters (e.g., based on the assistance information provided by the UE) to the UE to derive/determine the new PO(s) or PF(s) to monitor for receiving pages (e.g., paging DCI). In some implementations, a UE may stop applying new paging parameters or paging information (e.g., PO offset/PF offset/UE-ID offset) indicated in a NW command of a network (or PLMN) when the camped cell associated the impacted network (or PLMN) changes (e.g., due to cell reselection). In some implementations, a UE may stop applying new paging parameters or paging information (e.g., PO offset/PF offset/UE-ID offset) indicated in a NW command of a network (or PLMN) when a camped cell of the network (or PLMN) changes (e.g., due to cell reselection). In some implementations, a UE may stop applying new paging parameters or paging information (e.g., PO offset/PF offset/UE-ID offset) indicated in a NW command of a network (or PLMN) when the UE connects to the network (e.g., transition to RRC_CONNECTED state) or when the UE connects to another network (e.g., transition to RRC_CONNECTED state). In some implementations, if the multi-SIM operation (or dual-SIM operation) is off and a network becomes inactive (or is turned off), the UE may keep the new paging parameters (or paging information) (e.g., PO offset, PF offset, or UE-ID offset used in paging formula) of the inactive network (if received). In some implementations, if the multi-SIM operation (or dual-SIM operation) is off and a network becomes inactive (or is turned off), the UE may release the new paging parameters (or paging information) (e.g., PO offset, PF offset, or UE-ID offset used in paging formula) of the inactive network (if received).

In some implementations, a UE may apply the suggested/assisted paging parameters or paging information (e.g., an offset for the current PO(s) or an offset for the current PF(s)) to derive/determine the new PO(s) or PF(s) to monitor for receiving pages (e.g., paging DCI) (e.g., upon transmitting assistance information related paging collision resolution to a NW, upon initiating/applying a paging collision resolution procedure or upon a NW response). For example, if an offset is received via a NW response and the offset is applied for an impacted NW, each PO of the impacted NW may be shifted based on the offset in the time domain. For example, if a PO of the impacted NW is at T1 (e.g., the starting point of the PO) in the time domain and the offset is T2, the UE may monitor the PO at T1+T2 (e.g., the new starting point of the PO). In some implementations, the suggested/assisted paging parameters or paging information may be pre-configured/configured via dedicated signaling or broadcasting system information from a network. In some implementations, a UE may apply the suggested/assisted paging parameters or paging information (e.g., an offset for the current PO(s)) to derive/determine the new PO(s) or PF(s) to monitor for receiving pages (e.g., paging DCI), while receiving a NW command. In some implementations, a UE may stop applying the suggested/assisted paging parameters or paging information of a network (or PLMN) when the camped cell associated the impacted network (or PLMN) changes (e.g., due to cell reselection). In some implementations, a UE may stop applying the suggested/assisted paging parameters or paging information of a network (or PLMN) when a camped cell of the network (or PLMN) changes (e.g., due to cell reselection). In some implementations, a UE may stop applying the suggested/assisted paging parameters or paging information of a network (or PLMN) when the UE connects to the network (e.g., transition to RRC_CONNECTED state) or when the UE connects to another network (e.g., transition to RRC_CONNECTED state).

In some implementations, as shown in FIG. 1, when PLMN A (or Network B/Network A cell) and PLMN B (or Network B/Network B cell) are operating on the same spectrum/frequency band/frequency carrier, some UEs with dual-SIM (or multi-SIM) and {single RX, single TX} may not perform the related implementations of Solution #2 for paging collision resolution.

### Solution #3

In some implementations, if a first page (e.g., paging DCI, short message, or paging message) associated with a UE (e.g., a UE with dual-SIM (or multi-SIM) and/or {single RX, single TX}) is received, the UE may monitor the PO(s) (including collided PO and/or non-collided PO) of another network for a period to receive or attempt to receive a second page associated with the UE.

In some implementations, if a first page associated with a UE (e.g., a UE with dual-SIM (or multi-SIM) and/or {single RX, single TX}) is received and the first page is with the highest priority (or high priority), the UE may not monitor the PO(s) (including collided PO and/or non-collided PO) of another network, and instead perform an action (e.g., an RA procedure for RRC Connection Setup or RRC Connection Resume) in response to the first page. In some implementations, if a first page associated with a UE (e.g., a UE with dual-SIM (or multi-SIM) and/or {single RX, single TX}) is received and the first page is not with the highest priority (or high priority), the UE may monitor the PO(s) (including collided PO and/or non-collided PO) of another network for a time period to receive or attempt to receive a second page associated with the UE. If the second page associated with the UE is not received within the time period, the UE may perform an action (e.g., an RA procedure for RRC Connection Setup or RRC Connection Resume) in response to the first page. If the second page associated with the UE is received within the time period and the priority of the second page is higher than (or equal to) the priority of the first page, the UE may perform an action (e.g., an RA procedure for RRC Connection Setup or RRC Connection Resume) in response to the second page. If the second page associated with the UE is received within the time period and the priority of the second page is lower than (or equal to) the priority of the first page, the UE may perform an action (e.g., an RA procedure for RRC Connection Setup or RRC Connection Resume) in response to the first page. If the second page associated with the UE is received within the time period and the priority of the second page is equal to the priority of the first page, the UE may select one of the pages to respond (e.g., based on pre-configuration/pre-defined rules/policy/UE implementations).

In some implementations, if a first page associated with a UE (e.g., a UE with dual-SIM (or multi-SIM) and/or {single RX, single TX}) is received at a network with a lower priority, the UE may monitor the PO(s) (including collided PO and/or non-collided PO) of another network (with a higher priority or same priority) for a time period to receive or attempt to receive a second page associated with the UE. In some implementations, if a first page associated with a UE (e.g., a UE with dual-SIM (or multi-SIM) and/or {single RX, single TX}) is received at a network with a higher priority, the UE may not monitor the PO(s) (including collided PO and/or non-collided PO) of another network, and instead perform an action (e.g., an RA procedure for RRC Connection Setup or RRC Connection Resume) in response to the first page.

In some implementations, the time period may be configurable or pre-defined. In some implementations, the time period may be provided via system information or dedicated signaling. For example, the time period for Network A may be provided by Network A to the UE. For another example, the time period for Network A may be provided by Network B to the UE. The time period may be configurable or pre-defined. The time period may be provided via system information or dedicated signaling. In one implementation, the time period may be individually configured per NW (e.g., the UE assumes there is no timer if there is no valid stored configuration). In one implementation, the time period may be determined based on a scaling factor, which may rely on the number of SIMs supported for the multi-SIM operation, the number of TX/RX, and so on.

In some implementations, if a first page associated with a UE (e.g., a UE with dual-SIM (or multi-SIM) and/or {single RX, single TX}) is received and the first page is not with the highest priority (or a high priority), the UE may monitor the coming K PO(s) (including collided PO(s) and/or non-collided PO(s)) of another network to try to receive a second page associated with the UE. If the second page associated with the UE is not received after monitoring the K PO(s) of the other network, the UE may perform an action (e.g., an RA procedure for RRC Connection Setup or RRC Connection Resume) in response to the first page. If the second page associated with the UE is received when monitoring the coming K PO(s) of the other network and the priority of the second page is higher than (or equal to) the priority of the first page, the UE may perform an action (e.g., an RA procedure for RRC Connection Setup or RRC Connection Resume) in response to the second page. If the second page associated with the UE is received when monitoring the coming K PO(s) of the other network and the priority of the second page is lower than (or equal to) the priority of the first page, the UE may perform an action (e.g., an RA procedure for RRC Connection Setup or RRC Connection Resume) in response to the first page. If the second page associated with the UE is received when monitoring the coming K PO(s) of the other network and the priority of the second page is equal to the priority of the first page, the UE may select one of the pages to respond (e.g., based on pre-configuration/pre-defined rules/policy/UE implementations).

In some implementations, if a first page associated with a UE (e.g., a UE with dual-SIM (or multi-SIM) and/or {single RX, single TX}) is received at a network with a lower priority, the UE may monitor the coming K PO(s) (including collided PO and/or non-collided PO) of another network (with a higher priority or same priority) to receive or attempt to receive a second page associated with the UE. In some implementations, if a first page associated with a UE (e.g., a UE with dual-SIM (or multi-SIM) and/or {single RX, single TX}) is received at a network with a higher priority, the UE may not monitor the PO(s) (including collided PO and/or non-collided PO) of another network, and instead perform an action (e.g., an RA procedure for RRC Connection Setup or RRC Connection Resume) in response to the first page.

In some implementations, K may be configurable or pre-defined. In some implementations, K may be provided via system information or via dedicated signaling. For example, the K value for Network A may be provided by Network A to the UE. For another example, the K value for Network A may be provided by Network B to the UE. The K may be configurable or pre-defined. K may be provided via system information or dedicated signaling. In one implementation, K may be individually configured per NW (e.g., UE assume no timer if there is no valid stored configuration). In one implementation, that K may be determined based on a scaling factor and the factor may rely on the number of SIMS supported for the multi-SIM operation, the number of TX/RX, and so on.

In some implementations, as shown in FIG. 1, when PLMN A (or Network B/Network A cell) and PLMN B (or Network B/Network B cell) are operating on the same spectrum/frequency band/frequency carrier, some UEs with dual-SIM (or multi-SIM) and {single RX, single TX} may not perform the related implementations of Solution #3 for paging collision resolution.

Solutions #1, #2, and #3 may be combined (or partially combined) and performed by the UE.

### Informing the Network

In some implementations, a UE may inform a network that a paging collision resolution procedure is initiated or a paging collision resolution is requested. In some implementations, a UE may inform a network that a paging collision resolution procedure is initiated or a paging collision resolution is requested via an RA procedure (e.g., a 2-step RA procedure or a 4-step RA procedure). In some implementations, a UE may inform a network that a paging collision resolution procedure is initiated via an RA procedure (e.g., a 2-step RA procedure or a 4-step RA procedure) without transitioning to an RRC Connected state. For example, the UE may not include an RRC Setup Request message or an RRC Resume Request message in msgA of a 2-step RA procedure or in msg3 of a 4-step RA procedure. For example, the UE may include a paging collision resolution request or paging collision resolution assistance information in msgA of a 2-step RA procedure or in msg3 of a 4-step RA procedure.

In some implementations, an RRC Inactive UE may inform a network that a paging collision resolution procedure is initiated or a paging collision resolution is requested via a 2-step RA procedure by including the corresponding cause/intention/collision information and/or associated I-RNTI (e.g., a full I-RNTI or a short I-RNTI) in msgA payload. In some implementations, an RRC Inactive UE may inform a network that a paging collision resolution procedure is initiated or a paging collision resolution is requested via a 4-step RA procedure by including corresponding cause/intention/collision information and/or the associated I-RNTI (e.g., a full I-RNTI or a short I-RNTI) in msg3.

In some implementations, an RRC Idle UE may inform a network that a paging collision resolution procedure is initiated or a paging collision resolution is requested via a 2-step RA procedure by including corresponding cause/intention and/or the associated UE ID (e.g., 5G-S-TMSI or 5G-TMSI) in msgA payload. In some implementations, an RRC Inactive UE may inform a network that a paging collision resolution procedure is initiated or a paging collision resolution is requested via a 4-step RA procedure by including corresponding cause/intention/collision information and/or the associated I-RNTI (e.g., 5G-S-TMSI or 5G-TMSI) in msg3.

In some implementations, a UE may inform a network that a paging collision resolution procedure is initiated or a paging collision resolution is requested via pre-configured uplink grant(s). In some implementations, a UE may inform a network that a paging collision resolution procedure is initiated via a pre-configured uplink grant without transitioning to an RRC Connected state. For example, the UE may transmit a paging collision resolution request or a paging collision resolution assistance information in a pre-configured uplink grant.

In some implementations, an RRC Inactive UE may inform a network that a paging collision resolution procedure is initiated or a paging collision resolution is requested by transmitting the corresponding cause/intention/collision information and/or the associated I-RNTI (e.g., a full I-RNTI or a short I-RNTI) via pre-configured uplink grant(s).

In some implementations, an RRC Idle UE may inform a network that a paging collision resolution procedure is initiated or a paging collision resolution is requested by transmitting the corresponding cause/intention/collision information and/or associated UE ID (e.g., 5G-S-TMSI or 5G-TMSI) via pre-configured uplink grant(s).

In some implementations, a UE (e.g., a UE whose multi-SIM operation/dual-SIM operation is on) may inform a network that a paging collision resolution procedure is initiated or a paging collision resolution is requested when a camped cell of one of the associated networks changes.

In some implementations, a UE may inform a network that a paging collision resolution procedure is initiated. The network being informed may realize that the UE may monitor the new PO(s) or PF(s) (e.g., based on the pre-defined paging parameters or based on the preserved PO(s) or PF(s)).

In some implementations, a UE may provide assistance information (e.g., suggested/assisted paging parameters/paging information or the paging factors of another network) for a network to resolve paging collision (e.g., via an RRC Resume Request message, an RRC Setup Request message, another RRC message, a MAC CE or a NAS message). In some implementations, assistance information may include an offset value for the current determined PO(s). The offset value may be in, but not limited to, the unit of ms, subframe, or slot. In some implementations, assistance information may include, but not limited to, suggested paging parameters, such as a DRX cycle, the number of total paging frames in a DRX cycle, the number of paging occasions for a PF, an offset used for PF determination, a UE_ID, and an offset to the current UE_ID. The UE_ID may be a permanent subscription identifier (e.g., an IMSI) or a temporary identifier (e.g., a 5G-S-TMSI).

In some implementations, the UE may inform a network before/after a paging collision via MAC CE/UCI/lower-layer signal (e.g., upon a UE detects the paging collision or upon a UE has expected the paging collision). The UE may transmit the MAC CE/UCI/lower-layer signal to a network being impacted. The UE may transmit the MAC CE/UCI/lower-layer signal to a primary/prioritized network, which would not be impacted.

### UE/NW Capability

In some implementations, a UE may signal its capability of supporting paging collision resolution or paging collision resolution procedure to a network. In some implementations, a UE may signal its capability of supporting paging collision resolution or paging collision resolution procedure in RRC Idle and RRC Inactive state to the network. In some implementations, a UE may signal its capability of supporting paging collision resolution or paging collision resolution procedure in RRC Idle state to the network. In some implementations, a UE may signal its capability of supporting paging collision resolution or paging collision resolution procedure in RRC Inactive state. In some implementations, a UE may signal its capability of supporting paging collision resolution or paging collision resolution procedure in both NR-NR dual-SIM/multi-SIM operations and LTE-NR dual-SIM/multi-SIM operations. In some implementations, a UE may signal its capability of supporting paging collision resolution or paging collision resolution procedure in NR-NR dual-SIM/multi-SIM operations. In some implementations, a UE may signal its capability of supporting paging collision resolution or paging collision resolution procedure in NR-LTE dual-SIM/multi-SIM operations.

In some implementations, a base station may indicate whether it supports paging collision resolution or paging collision resolution procedure (e.g., via RRC signaling or NAS signaling). For example, a base station (or an associated cell) may broadcast an indication in system information to indicate whether the base station (or the cell) supports paging collision resolution or paging collision resolution procedure. For example, if an indication (e.g., in RRC signaling or NAS signaling) to indicate the base station (or the cell) supports paging collision resolution or paging collision resolution procedure, a UE may be allowed to perform paging collision resolution or initiate a paging collision resolution procedure. For example, if an indication to indicate the base station (or the cell) supports paging collision resolution or paging collision resolution procedure, a UE may be allowed to inform a network that a paging collision resolution procedure is initiated or a paging collision resolution is requested. For example, if an indication indicates that the base station (or the cell) supports paging collision resolution or paging collision resolution procedure, a UE may be allowed to transmit the assistance information related to paging collision resolution or paging collision resolution procedure.

In some implementations, a base station may indicate whether it supports paging collision resolution or paging collision resolution procedure in RRC Idle state and RRC Inactive state. In some implementations, a base station may indicate whether it supports paging collision resolution or paging collision resolution procedure in RRC Idle state. In some implementations, a base station may indicate whether it supports paging collision resolution or paging collision resolution procedure in RRC Inactive state. In some implementations, a base station may indicate whether it supports paging collision resolution or paging collision resolution procedure for a UE in both NR-NR dual-SIM/multi-SIM operations and LTE-NR dual-SIM/multi-SIM operations. In some implementations, a base station may indicate whether it supports paging collision resolution or paging collision resolution procedure for a UE in NR-NR dual-SIM/multi-SIM operations. In some implementations, a base station may indicate whether it supports paging collision resolution or paging collision resolution procedure for a UE in LTE-NR dual-SIM/multi-SIM operations. In some implementations, a base station may indicate whether it supports paging collision resolution or paging collision resolution procedure for a UE in LTE-LTE dual-SIM/multi-SIM operations.

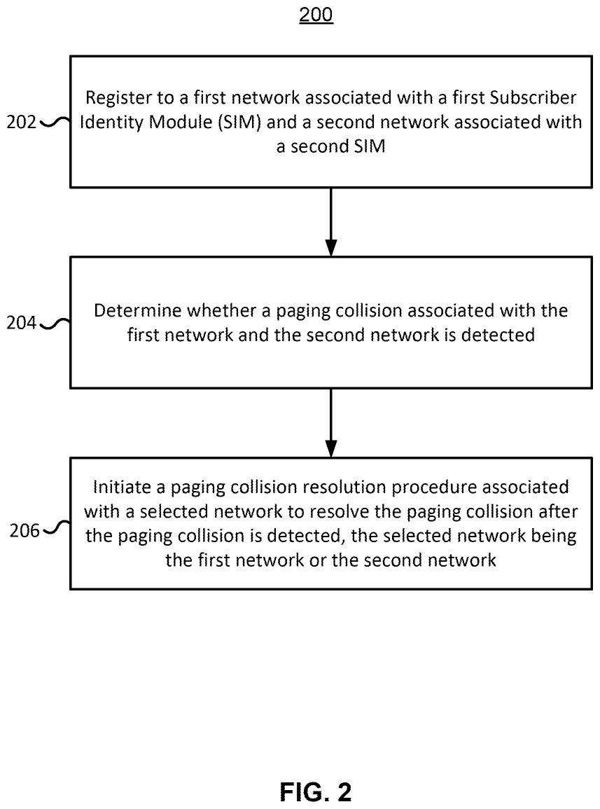

FIG. 2 is a flowchart illustrating a method 200 performed by a UE for a multi-SIM operation according to an example implementation of the present disclosure.

In action 202, the UE may register to a first network associated with a first SIM and a second network associated with a second SIM. The UE may register to one or more networks (e.g., the first network and the second network) from which the UE may receive pages.

In action 204, the UE may determine whether a paging collision associated with the first network and the second network is detected. In one implementation, an upper layer (e.g., NAS layer or Application layer) of UE may transmit a status of the multi-SIM operation to a lower layer (e.g., RRC layer) of the UE to inform the lower layer that the multi-SIM operation is activated. In one implementation, the upper layer (e.g., NAS layer or Application layer) of UE may transmit architecture information to the lower layer (e.g., RRC layer), where the architecture information includes a number of receivers in the UE. In one implementation, when the paging occasions for the first network and the second network overlap in the time domain, the UE may determine that the paging collision associated with the first network and the second network is detected. In one implementation, when the paging occasions for the first network and the paging occasions for the second network overlap in the time domain, the UE may determine that the paging collision event is detected.

In action 206, the UE may initiate a paging collision resolution procedure associated with a selected network to resolve the paging collision after the paging collision is detected, the selected network is the first network or the second network. In one implementation, the selected network may be determined based on priorities of the first network and the second network. The priorities of the first network and the second network may be determined based on pre-defined rule(s), pre-configuration(s), policy(ies), UE implementation(s) (e.g., the network(s) associated with a SIM that is plugged in/installed first or manual selected), associated RRC state(s), network type(s) (e.g., public network or private network), serving frequency(ies), or associated core network(s).

In one implementation, the paging collision resolution procedure may include that the UE transmits assistance information to the selected network, and receives a command from the selected network after transmitting the assistance information. The command may include new paging information associated with the selected network to calculate new paging occasions for the selected network. In one implementation, the new paging information is an offset to UE identity (ID) of the UE. In one implementation, the paging collision resolution procedure may include that the UE omits monitoring a collided PO or a collided PF of the selected network.

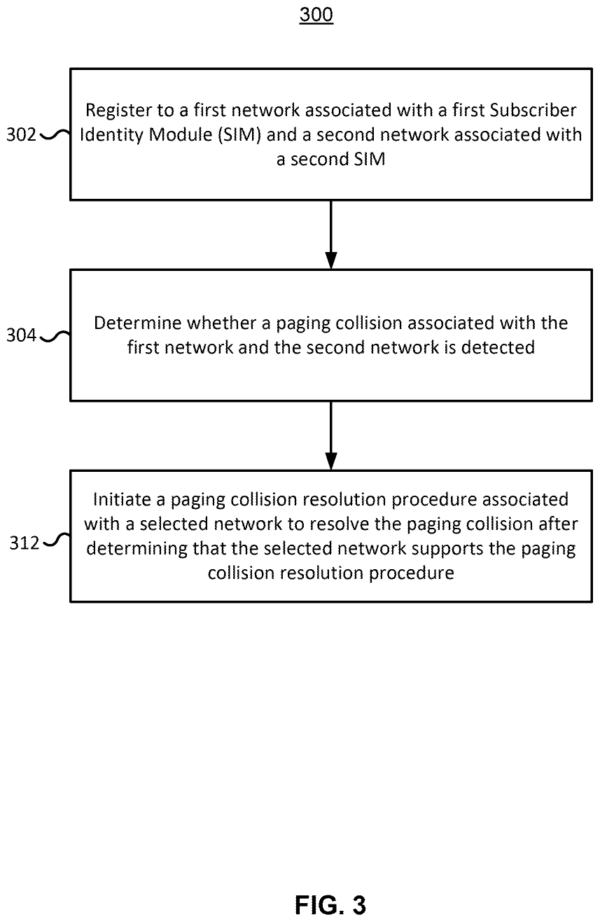

FIG. 3 is a flowchart illustrating a method performed by a UE for a multi-SIM operation according to another example implementation of the present disclosure. Actions 302 and 304 in FIG. 3 may correspond to actions 202 and 204, respectively, in FIG. 2.

In action 312, the UE may initiate a paging collision resolution procedure associated with a selected network to resolve the paging collision after determining that the selected network indicates support of the paging collision resolution procedure, the selected network is the first network or the second network. In one implementation, the selected network may be determined based on priorities of the first network and the second network. The priorities of the first network and the second network may be determined based on pre-defined rule(s), pre-configuration(s), policy(ies), UE implementation(s) (e.g., the network(s) associated with a SIM that is plugged in/installed first or manual selected), associated RRC state(s), network type(s) (e.g., public network or private network), serving frequency(ies), or associated core network(s). In another implementation, the selected network may be determined based on pre-defined rule(s), pre-configuration(s), policy(ies), or UE implementation(s) (e.g., the network(s) associated with a SIM/USIM that is plugged in/installed first or manual selected).

In one implementation, the selected network may indicate whether paging collision resolution procedure is supported via system information or dedicated signaling. For example, the selected network may broadcast an indication in system information to indicate the selected network supports collision resolution procedure. For example, if an indication indicates the selected network supports paging collision resolution procedure, the UE may be allowed to initiate a paging collision resolution procedure.

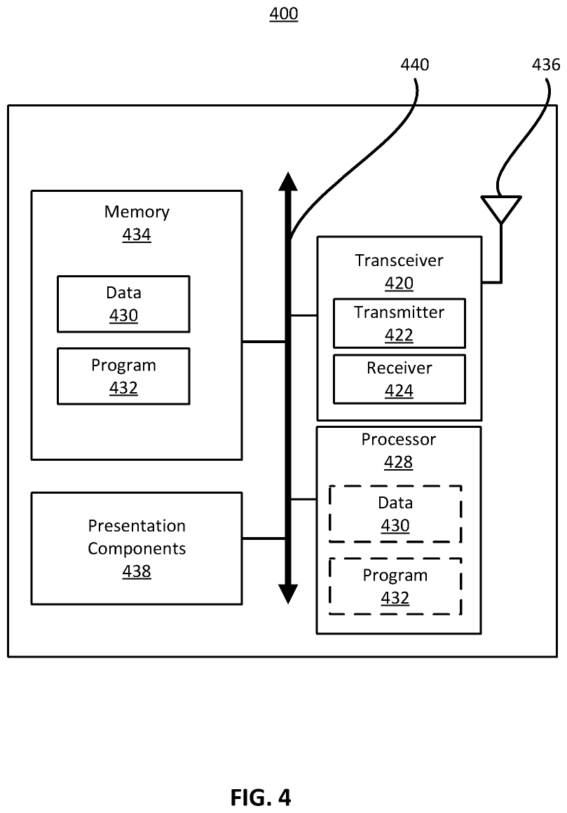

FIG. 4 is a block diagram illustrating a node 400 for wireless communication in accordance with various aspects of the present disclosure. As illustrated in FIG. 4, a node 400 may include a transceiver 420, a processor 428, a memory 434, one or more presentation components 438, and at least one antenna 436. The node 400 may also include a radio frequency (RF) spectrum band module, a BS communications module, a network communications module, and a system communications management module, Input/Output (I/O) ports, I/O components, and a power supply (not illustrated in FIG. 4).

Each of the components may directly or indirectly communicate with each other over one or more buses 440. The node 400 may be a UE or a BS that performs various functions disclosed with reference to FIGS. 2 and 3.

The transceiver 420 has a transmitter 422 (e.g., transmitting/transmission circuitry) and a receiver 424 (e.g., receiving/reception circuitry) and may be configured to transmit and/or receive time and/or frequency resource partitioning information. The transceiver 420 may be configured to transmit in different types of subframes and slots including but not limited to usable, non-usable and flexibly usable subframes and slot formats. The transceiver 420 may be configured to receive data and control channels.

The node 400 may include a variety of computer-readable media. Computer-readable media may be any available media that may be accessed by the node 400 and include volatile (and/or non-volatile) media and removable (and/or non-removable) media.

The computer-readable media may include computer-storage media and communication media. Computer-storage media may include both volatile (and/or non-volatile media), and removable (and/or non-removable) media implemented in any method or technology for storage of information such as computer-readable instructions, data structures, program modules or data.

Computer-storage media may include RAM, ROM, EPROM, EEPROM, flash memory (or other memory technology), CD-ROM, Digital Versatile Disks (DVD) (or other optical disk storage), magnetic cassettes, magnetic tape, magnetic disk storage (or other magnetic storage devices), etc. Computer-storage media may not include a propagated data signal. Communication media may typically embody computer-readable instructions, data structures, program modules or other data in a modulated data signal such as a carrier wave or other transport mechanisms and include any information delivery media.

The term “modulated data signal” may mean a signal that has one or more of its characteristics set or changed in such a manner as to encode information in the signal. Communication media may include wired media such as a wired network or direct-wired connection, and wireless media such as acoustic, RF, infrared and other wireless media. Combinations of any of the previously listed components should also be included within the scope of computer-readable media.

The memory 434 may include computer-storage media in the form of volatile and/or non-volatile memory. The memory 434 may be removable, non-removable, or a combination thereof. Example memory may include solid-state memory, hard drives, optical-disc drives, etc. As illustrated in FIG. 4, the memory 434 may store a computer-readable and/or computer-executable program 432 (e.g., software codes) that are configured to, when executed, cause the processor 428 to perform various functions disclosed herein, for example, with reference to FIGS. 2 and 3. Alternatively, the program 432 may not be directly executable by the processor 428 but may be configured to cause the node 400 (e.g., when compiled and executed) to perform various functions disclosed herein.

The processor 428 (e.g., having processing circuitry) may include an intelligent hardware device, e.g., a Central Processing Unit (CPU), a microcontroller, an ASIC, etc. The processor 428 may include memory. The processor 428 may process the data 430 and the program 432 received from the memory 434, and information transmitted and received via the transceiver 420, the base band communications module, and/or the network communications module. The processor 428 may also process information to send to the transceiver 420 for transmission via the antenna 436 to the network communications module for transmission to a CN.

One or more presentation components 438 may present data indications to a person or another device. Examples of presentation components 438 may include a display device, a speaker, a printing component, a vibrating component, etc.

In view of the present disclosure, it is obvious that various techniques may be used for implementing the disclosed concepts without departing from the scope of those concepts. Moreover, while the concepts have been disclosed with specific reference to certain implementations, a person of ordinary skill in the art may recognize that changes may be made in form and detail without departing from the scope of those concepts. As such, the disclosed implementations are to be considered in all respects as illustrative and not restrictive. It should also be understood that the present disclosure is not limited to the particular implementations disclosed and many rearrangements, modifications, and substitutions are possible without departing from the scope of the present disclosure.

1. A method for a multi-subscriber identity module (multi-SIM) operation performed by a user equipment (UE), the method comprising:
registering to a first network associated with a first Subscriber Identity Module (SIM) and a second network associated with a second SIM;
determining whether a paging collision associated with the first network and the second network is detected; and
initiating a paging collision resolution procedure associated with a selected network to resolve the paging collision after the paging collision is detected, the selected network being the first network or the second network.

2. The method according to claim 1, wherein a non-access stratum (NAS) layer of the UE transmits a status of the multi-SIM operation to a radio resource control (RRC) layer of the UE to inform the RRC layer of the UE that the multi-SIM operation is activated.

3. The method according to claim 1, wherein a non-access stratum (NAS) layer of the UE transmits architecture information to a radio resource control (RRC) RRC layer of the UE, the architecture information comprising a number of receivers in the UE.

4. The method according to claim 1, wherein initiating the paging collision resolution procedure associated with the selected network comprises
transmitting, to the selected network, assistance information including a suggested paging parameter.

5. The method according to claim 4, further comprising:
receiving a command from the selected network after transmitting the assistance information.

6. The method according to claim 5, wherein the command includes new paging information associated with the selected network to calculate new paging occasions for the selected network.

7. The method according to claim 6, wherein the new paging information is an offset to a UE identity (ID) of the UE.

8. The method according to claim 1, wherein the selected network is determined based on priorities of the first network and the second network.

9. The method according to claim 1, wherein initiating the paging collision resolution procedure associated with the selected network comprises omitting monitoring a collided paging occasion (PO) or a collided paging frame (PF) of the selected network.

10. The method according to claim 1, further comprising:
initiating the paging collision resolution procedure associated with the selected network to resolve the paging collision after determining that the selected network supports the paging collision resolution procedure.

11. A user equipment (UE) for a multi-subscriber identity module (multi-SIM) operation, the UE comprising:
one or more non-transitory computer-readable media storing computer-executable instructions; and
at least one processor coupled to the one or more non-transitory computer-readable media, the at least one processor being configured to execute the computer-executable instructions to cause the UE to:
register to a first network associated with a first Subscriber Identity Module (SIM) and a second network associated with a second SIM;
determine whether a paging collision associated with the first network and the second network is detected; and
initiate a paging collision resolution procedure associated with a selected network to resolve the paging collision after the paging collision is detected, the selected network being the first network or the second network.

12. The UE according to claim 11, wherein a non-access stratum (NAS) layer of the UE transmits a status of the multi-SIM operation to a radio resource control (RRC) layer of the UE to inform the RRC layer of the UE that the multi-SIM operation is activated.

13. The UE according to claim 11, wherein a non-access stratum (NAS) layer of the UE transmits architecture information to a radio resource control (RRC) layer of the UE, the architecture information comprising a number of receivers in the UE.

14. The UE according to claim 11, wherein initiating the paging collision resolution procedure associated with the selected network comprises
transmitting, to the selected network, assistance information including a suggested paging parameter.

15. The UE according to claim 14, wherein the at least one processor is further configured to execute the computer-executable instructions to cause the UE to:
receive a command from the selected network after transmitting the assistance information.

16. The UE according to claim 15, wherein the command includes new paging information associated with the selected network to calculate new paging occasions for the selected network.

17. The UE according to claim 16, wherein the new paging information is an offset to a UE identity (ID) of the UE.

18. The UE according to claim 11, wherein the selected network is determined based on priorities of the first network and the second network.

19. The UE according to claim 11, wherein initiating the paging collision resolution procedure associated with the selected network comprises
omitting monitoring a collided paging occasion (PO) or a collided paging frame (PF) of the selected network.

20. The UE according to claim 11, wherein the at least one processor is further configured to execute the computer-executable instructions to cause the UE to:
initiate the paging collision resolution procedure associated with the selected network to resolve the paging collision after determining that the selected network supports the paging collision resolution procedure.
